(19) United States
(12) Patent Application Publication
(10) Pub. No.: US 2002/0146993 A1
(43) Pub. Date: Oct. 10, 2002

(54) Bias adjustment for power amplifier

(76) Inventors: Charles Persico, Santa Fe, CA (US); Jonathan Klaren, San Diego, CA (US); Vladimir Aparin, San Diego, CA (US)

Correspondence Address: QUALCOMM Incorporated, Attn: Patent Department, 5775 Morehouse Drive, San Diego, CA, 92121-1714, US

(21) Appl. No.: 09/826,182

(22) Filed: Apr. 4, 2001

(51) Int. Cl. H04B 7/00

(52) U.S. Cl. 455/126; 455/127; 455/241.1

(57) ABSTRACT

A power amplifier having bias that may be automatically adjusted based on a detected output power level. The amplifier includes one or more amplifier stages operatively coupled to a control unit. The amplifier stage(s) couple together (e.g., in series) and receive and amplify an RF input signal to provide an RF output signal. A power detector detects the RF output signal level (or power) and provides a detected signal. A control unit conditions the detected signal (e.g., with a particular transfer characteristic) to provide at least one conditioned signal. A bias control generator receives the conditioned signal(s) and provides at least one bias control signal, with each bias control signal used to adjust the bias of a respective amplifier stage. The bias adjustment is performed in a manner to achieve the desired level of linearity while minimizing power consumption.

### BACKGROUND

1. Field

The present invention relates to circuits. More particularly, the present invention relates to novel and improved techniques for adjusting the bias of a power amplifier (PA) to achieve high performance and efficiency.

2. Background

The design of a high performance transmitter is made challenging by various design considerations. First, high performance is required for many applications, and is typically characterized by the linearity of the active devices (e.g., amplifiers, mixers, and so on) in the transmit signal path and their noise performance. Second, for some applications such as wireless communication systems, low power consumption is an important design goal because of the portable nature of the cellular phones or remote terminals. High performance and low power consumption typically impose conflicting design constraints.

In addition to the above design goals, a transmitter may be required to provide a wide range of adjustment in the transmit output power. One such application that requires this wide power adjustment is a Code Division Multiple Access (CDMA) communication system. In the CDMA system, the signal from each user is spectrally spread over the entire (e.g., 1.2288 MHz) system bandwidth. Thus, the transmitted signal from each transmitting user acts as interference to those of other users in the system. To minimize interference and increase system capacity, the output power of each transmitting remote terminal is adjusted such that the required level of performance (e.g., a particular bit error rate) is maintained while minimizing interference to other users.

The transmitted signal from a remote terminal is affected by various transmission phenomenons such as path loss and fading. These phenomenons, in combination with the need to control the transmit power, can impose difficult specifications on the required transmit power adjustment range. In fact, for the CDMA system, each remote terminal transmitter may be required to be able to adjust its output power over a range of approximately 85 dB.

The linearity of a remote terminal transmitter is also specified for some CDMA systems (indirectly, by an adjacent channel power rejection (ACPR) specification). For many active circuits (e.g., power amplifier), linearity is determined, in part, by the amount of current used to bias the circuits. Greater linearity may typically be achieved by using greater amounts of bias current. Also, to maintain a required level of linearity for a large signal level, greater amounts of bias current is typically required.

To achieve the required level of linearity at all (including high) output power levels, the active circuits in the transmit signal path can be biased with large amounts of current. This biasing scheme would ensure that the required level of linearity is provided at all transmit power levels, including at the specified maximum output power level. However, this scheme consumes large amounts of bias current at all times, even during transmissions at lower output power levels, and results in wasteful consumption of power.

A power amplifier (PA), which typically includes multiple stages, is also typically the last gain stage in the transmit signal path and thus operates on the largest signal level in the path. To provide the required signal drive at high output power levels, the power amplifier is typically biased with a large amount of current (relative to other active circuits the transmit path). Thus, techniques for adjusting the bias current of the power amplifier to provide high performance (e.g., the required level of linearity) and efficiency (i.e., low power consumption) are especially desirable.

### SUMMARY

Aspects of the invention provide a power amplifier having bias that may be adjusted based on a detected output power level from the power amplifier. The bias adjustment is performed in a manner to achieve the desired level of linearity while minimizing power consumption. Accurate bias control is possible since the bias adjustment is based on the detected output power level, and not on some indirect indication of the power level (e.g., the gain settings of the power amplifier) or input power.

A specific embodiment of the invention provides a bias controlled (power) amplifier that includes one or more amplifier stages operatively coupled to a control unit. The amplifier stage(s) couple together (e.g., in series) and receive and amplify an RF input signal to provide an RF output signal. A coupler is typically used to couple a portion of the RF output signal to the control unit.

In one design, the control unit includes a power detector, a conditioning unit, and a bias control generator. The power detector detects the RF output signal level (or power) based on the coupled portion, and provides a detected signal indicative of the detected output signal level. The conditioning unit conditions the detected signal (e.g., with a particular transfer characteristic) to provide at least one conditioned signal. The bias control generator receives the conditioned signal(s) and provides at least one bias control signal, with each bias control signal used to adjust the bias of a respective amplifier stage.

The invention further provides methods, apparatus, and elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a block diagram of a specific design of a transmitter that implements some aspects of the invention;

FIG. 2 is a diagram of a CDMA spread spectrum signal and some of the distortion components generated by non-linearity in the active circuits in the transmit signal path;

FIG. 3 is a diagram of a power amplifier with bias adjusted based on a detected RF output power level, in accordance with an embodiment of the invention;

FIGS. 4A and 4B are diagrams of two embodiments of a bias control circuit for generating bias control signals for the power amplifier stages;

FIGS. 5A and 5B are schematic diagrams of a specific design of a power amplifier stage and an associated bias voltage generator, respectively;

FIGS. 6A and 6B are diagrams respectively illustrating (1) the gain of an amplifier stage versus RF output power level for a particular bias current setting and (2) the bias current of the amplifier stage versus RF output power level for a desired performance level;

FIG. 7 is a schematic diagram of an embodiment of a power detector; and

FIG. 8 is a schematic diagram of an embodiment of a log amplifier.

### DETAILED DESCRIPTION

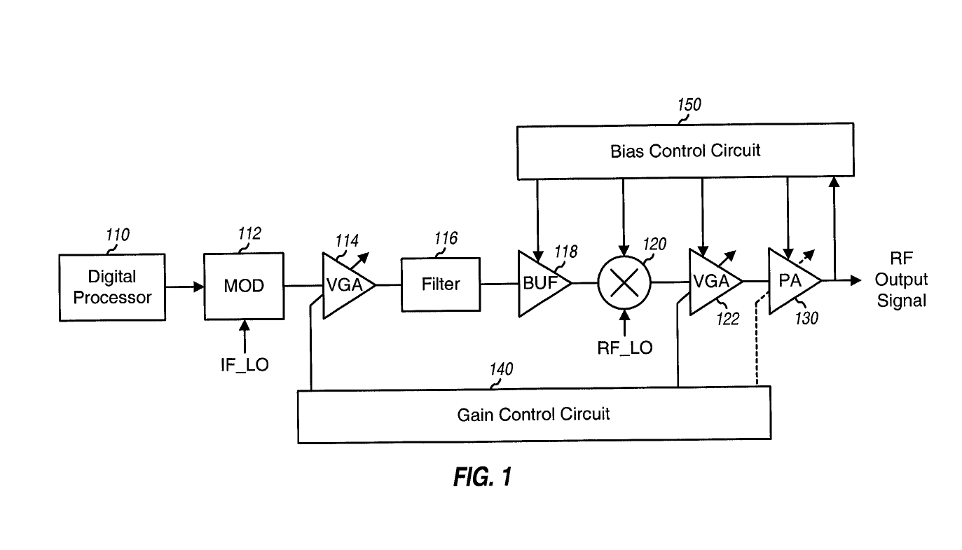

FIG. 1 is a block diagram of a specific design of a transmitter 100 that implement some aspects of the invention. A digital processor 110 generates data, encodes and modulates the data, and converts the digitally processed data into one or more analog signals. The analog signal(s) may be inphase (I) and quadrature (Q) baseband signals, or may be an intermediate frequency (IF) modulated signal. If the analog signals are baseband signals (as shown in FIG. 1), a modulator (MOD) 112 receives and modulates the baseband signals with a carrier signal (IF_LO) to generate an IF modulated signal.

An IF variable gain amplifier (IF VGA) 114 receives and amplifies the IF modulated signal with a first gain determined by a gain control circuit 140. The amplified IF signal is provided to a filter 116, which filters the signal to remove out-of-band noise and undesired signals. Filter 116 is typically a bandpass filter (e.g., a SAW filter).

The filtered IF signal is then provided to an IF buffer 118, which buffers the signal and provides the buffered IF signal to a mixer 120. Mixer 120 also receives another carrier signal at a radio frequency (RF_LO) and upconverts the buffered IF signal with the RF_LO to generate a RF signal. Mixer 120 may be a single sideband mixer or a double sideband mixer.

An RF VGA 122 receives and amplifies the RF signal with a second gain determined by gain control circuit 140. The amplified RF signal is then provided to a power amplifier (PA) 130, which buffers the signal and provides an RF output signal having the required signal drive. Power amplifier 130 drives an antenna via various circuits such as, for example, a filter for filtering images and spurious signals, an isolator, and a duplexer (not shown in FIG. 1 for simplicity).

FIG. 1 shows a specific transmitter design that may advantageously employ the power control techniques described herein. Various modifications may be made to the transmitter design shown in FIG. 1. For example, fewer or additional filters, buffers, and amplifier stages may be provided in the transmit signal path. Moreover, the elements within the signal path may be arranged in different configurations. In addition, the variable gain in the transmit signal path may be provided by VGAs (as shown in FIG. 1), variable attenuators, multipliers, other variable gain elements, or a combination thereof. In another transmitter design, a direct upconversion architecture is used and the power amplifier receives a modulated RF signal directly. In general, the power control techniques described herein may be used for a power amplifier regardless of how the modulated RF signal is generated.

In a specific implementation, the transmit signal path from modulator 112 to power amplifier 130 (possibly excluding filter 116) is implemented within one or more integrated circuits, although discrete elements may also be used.

For certain applications, the power amplifier is required to provide an output signal over a wide range of signal levels. For example, for some CDMA systems, the transmit output power from a remote terminal is required to be adjustable over a range of 85 dB, and the remote terminal may be designed to transmit from between approximately −50 dBm to +23 dBm.

The circuits in the transmit signal path are typically operated to amplify or attenuate the signal so that a proper signal level is provided to the power amplifier. The power amplifier may be designed with a fixed gain but variable drive capability. The fixed gain may be provided by multiple (series-coupled) stages.

The active circuits in the transmit signal path are designed and operated to provide the required level of linearity. The linearity of many active circuits is determined, in part, by the amount of current used to bias the circuits. Greater linearity can typically be achieved by using greater amounts of bias current. Also, to maintain the required level of linearity for larger signal levels, greater amounts of bias current is typically required.

The transmit signal path is typically designed to provide the required level of performance (e.g., linearity) at the worst-case (i.e., maximum) output power level. The required performance level may be achieved by biasing the circuits in the transmit signal path with high bias current. However, for some transmitters such as those in CDMA remote terminals, the maximum transmission condition occurs only some of the time. Thus, in accordance with aspects of the invention, the bias current of the power amplifier is reduced when not required (i.e., when transmitting at less than the maximum output power level).

As shown in FIG. 1, a bias control circuit 150 receives a portion of the RF output signal, and may further receive one or more gain control signals from gain control circuit 140 (not shown). Bias control circuit 150 then adjusts the bias current of power amplifier 130 (and possibly IF buffer 118, mixer 120, and RF VGA 122) based on the detected RF output power level. The bias control for the elements in the transmit signal path are typically not ganged together. Gain control circuit 140 can adjust the gain of VGAs 114 and 122 and possibly power amplifier 130 (as shown by the dashed line) based on control signals from processor 110 and/or the detected RF output power. The adjustment of the bias current for the power amplifier is described in further detail below.

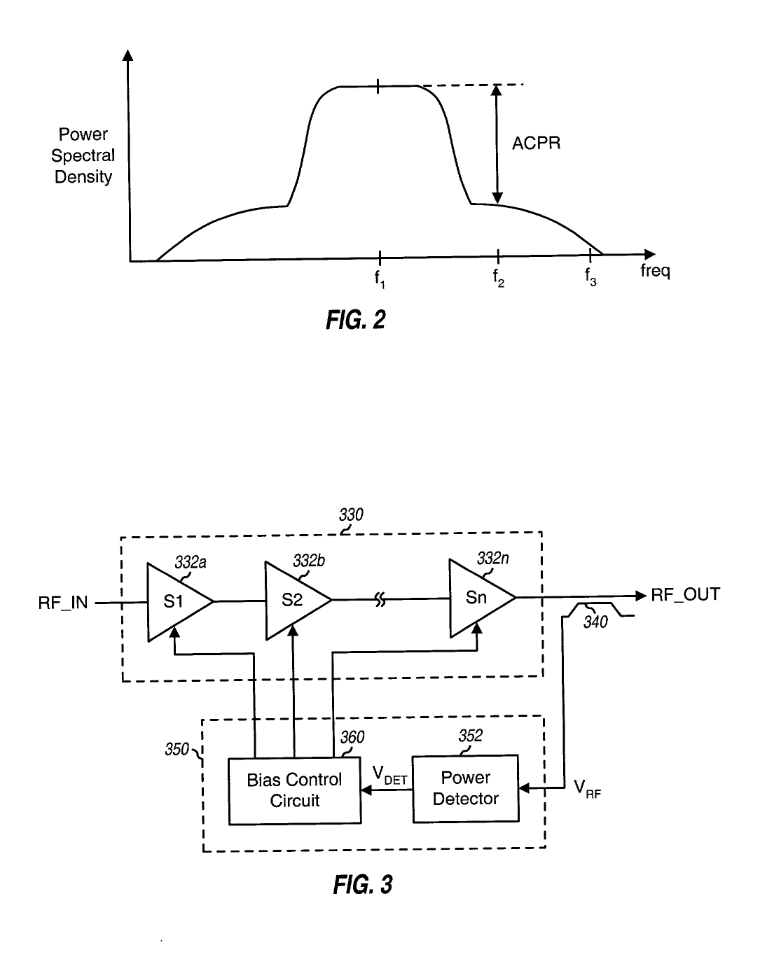

FIG. 2 is a diagram of a CDMA spread spectrum signal and some of the distortion components generated by non-linearity in the active circuits in the transmit signal path. Each active device, such as the power amplifier, has the following transfer function:

y(x)=a₁·x+a₂·x²+a₃·x³+a₄·x⁴+a₅·x⁵+. . . higher order terms. Eq (1)

where x is the input signal, y(x) is the output signal, and a₁, a₂, a₃, a₄, a₅, and so on, are coefficients that define the linearity of the active circuit. The Volterra series shown in equation (1) may not be adequate for a power amplifier because high order of terms is needed to represent non-linearity due to clipping. For an ideal active circuit, all coefficients except for a₁, are 0.0, and the output signal y(x) is simply the input signal x scaled by a₁. However, all active circuits experience some amounts of non-linearity, which is quantified by the values of the coefficients a₂, a₃, a₄, a₅, and so on. Coefficients a₂, a₄, and so on, define the amount of even-order non-linearity, and coefficients a₃, a₅, and so on, define the amount of odd-order non-linearity. The odd-order terms fall at frequencies in-band and thus determine linearity. The third and fifth order terms typically contribute most to adjacent channel power rejection (ACPR) at the frequency offsets of interest. The oven-order terms are out-of-band and can be more easily filtered out. However, the even-order terms do have some effect in-band (e.g., 2ω₂-ω₁) since third order contains second order terms.

As shown in FIG. 2, the CDMA signal has a particular bandwidth (e.g., 1.2288 MHz) and a particular center frequency, f₁, that is dependent on the operating band (e.g., cellular or PCS) of the system. The distortion components are generated from the CDMA signal itself due to third and higher order non-linearity in the circuits in the transmit signal path. The distortion components (which are sometimes referred to as spectral regrowth) comprise in-band components that reside within the frequency band of the CDMA signal and out-of-band components that reside in the adjacent frequency bands. The distortion components act as interference to the CDMA signal and to the signals in the adjacent bands.

For third order non-linearity, signal components at frequencies of ωₐ and ω_{b} produce intermodulation products at frequencies of (2ωₐ-ω_{b}) and (2ω_{b}-ωₐ). Thus, in-band signal components can produce intermodulation products that fall in-band or near-band. These products can cause degradation in the CDMA signal itself and the signals in the adjacent bands. To compound the problem, the amplitude of the third-order intermodulation products is scaled by aₐ·a_{b}² and aₐ²·a_{b}, where aₐ and a_{b} are the gains of the signal components at (ωₐ and ω_{b}, respectively. Thus, every doubling of the amplitude of the CDMA signal produces an eight-fold increase in the amplitude of the third order products. Higher order terms may be analyzed in similar manner.

For CDMA systems, the linearity of the remote terminal transmitter is specified by the adjacent channel power rejection (ACPR) specifications (e.g., in the IS-95-A, IS-98, and UMTS (W-CDMA) standards). The ACPR specifications generally apply to the entire transmit signal path, including the power amplifier. During the design phase, the ACPR specifications are typically “apportioned”to different sections of the transmit signal path, and each section is then designed to meet the apportioned specifications. For example, the section of the transmit signal path from processor 110 up to but not including power amplifier 130 may be required to maintain the distortion components at −42 dBc per 30 KHz bandwidth at 885 KHz offset from the CDMA center frequency, and −56 dBc per 30 KHz bandwidth at 1.98 MHz offset.

As noted above, the linearity of an active circuit is dependent, to an extent, on the amount of bias current provided to the circuit, and greater linearity (i.e., smaller values for a², a³, and so on) may be achieved with greater amounts of bias current. Also, more bias current is generally required for larger signal levels since the bias current itself is used to generate the output signal. However, consumption of more current than necessary is highly undesirable for a mobile transmitter unit.

In accordance with aspects of the invention, to achieve the desired level of linearity and minimize power consumption, the bias current of the active circuit (e.g., power amplifier) is adjusted based on the detected output power level from the power amplifier.

FIG. 3 is a diagram of a power amplifier 330 with bias current adjusted based on a detected RF output power level, in accordance with an embodiment of the invention. Power amplifier 330 may be used for power amplifier 130 in FIG. 1, and includes a number of (N) stages 332a through 332n coupled in cascade, where N can be any integer one or greater. Each stage 332 receives either the power amplifier RF input signal (RF_IN) or an output signal from a preceding stage. Each stage then amplifies the received signal and provides either a signal to the following stage or the RF output signal (RF_OUT).

An RF coupler 340 operatively couples to the output of power amplifier 330 and provides a fraction of the RF output signal to a control unit 350. The amount of RF power to be coupled may be, for example, −20 dB, −30 dB, or some other fraction of the RF output signal.

Control unit 350 receives the coupled RF output power from coupler 340 and provides one or more bias control signals used to adjust the bias of power amplifier 330. In the embodiment shown in FIG. 3, control unit 350 includes an RF power detector 352 coupled to a bias control circuit 360. RF power detector 352 receives the coupled RF signal, V_{RF}, and provides a detected signal, V_{DET}, indicative of the detected peak RF voltage of the coupled RF signal. RF power detector 352 may be designed to detect the envelop of the RF signal, and the detected signal may have an amplitude that is related to the RF signal's power level (e.g., V_{DET} [symbol] V_{RF} [symbol] P_{OUT} where P_{OUT} is the RF output power). In an alternative embodiment, a true RMS power detector may be used to provide a detected signal that is proportional to the RF output power (i.e., V_{DET} [symbol] RF Power) in RMS Watts.

Bias control circuit 360 receives and conditions (e.g., filters, amplifies, and buffers) the detected signal to provide one or more conditioned signals. Based on the conditioned signal(s), bias control circuit 360 provides one or more bias control signals for power amplifier 330. Depending on the particular design of power amplifier 330, the one or more bias control signals may be used to control/adjust the bias current or bias voltage of one or more stages of the power amplifier.

The bias control signals may be generated based on various bias adjustment schemes. Generally, the bias of one, several, or all N stages of power amplifier 330 may be adjusted to achieve the desired results. The amount of bias current for each stage may be dependent on the particular design of the stage, the stage output power level (which may be inferred from the detected RF output power level), the performance to be achieved, and possibly other factors. By adjusting the bias of the power amplifier stages based on the detected RF output power level, the required level of linearity is achieved while idle current is reduced or minimized. The bias adjustment is especially advantageous when the power amplifier is required to provide low RF output power levels for transmitters that typically transmit at low power.

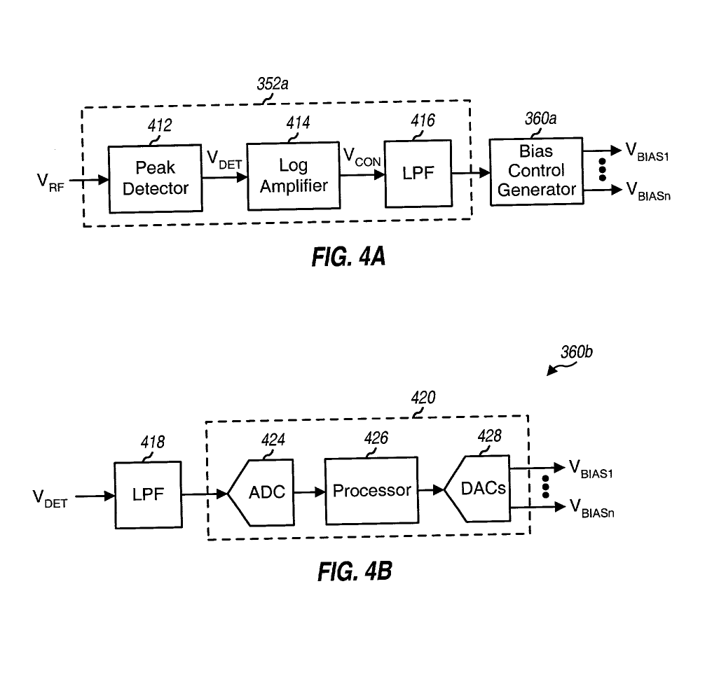

FIG. 4A is a diagram of an embodiment of an RF power detector 352a and a bias control circuit 360a, which is one implementation of RF power detector 352 and bias control circuit 360 respectively in FIG. 3. RF power detector 352a may be designed as a peak detector that detects the peak signal amplitude in the RF signal. Thus, within RF power detector 352a, the coupled RF signal is provided to a peak detector 412, which detects the peak RF voltage on the received signal and provide the detected signal, V_{DET}.

The detected signal, V_{DET}, from peak detector 412 is provided to a logarithmic (log) amplifier 414, which amplifies the filtered signal based on a logarithm transfer function and provides a conditioned signal, V_{CON}, having a magnitude (e.g., a voltage) that is a logarithm of the detected signal, V_{DET}. Since V_{DET} [symbol] V_{RF}, V_{RF}² [symbol] P_{OUT}(linear), and V_{DET}² [symbol] P_{OUT}(linear), then 2logV_{DET} [symbol] logP_{OUT} and 2logV_{DET} [symbol] P_{OUT}(dBm). The function of log amplifier 414 is to provide a conditioned signal, V_{CON}, that is a function of the RF output power (i.e., V_{CON} [symbol] P_{OUT}(dBm)). However, log amplifier 414 introduces error into that function over temperature, and is internally compensated.

The conditioned signal from log amplifier 414 is then provided a lowpass filter (LPF) 416, which filters the RF envelope in the detected signal and provides a filtered signal. Some transmitted modulated signals exhibit a time-varying envelope or AM modulated component. For example, a CDMA system typically includes an RF envelope of approximately 1 MHz corresponding to a finite impulse response (FIR) filter applied to baseband data. This envelope and other high frequency noise and spurious signals may be filtered by lowpass filter 416. Lowpass filter 416 may be implemented as a simple (e.g., first-order) RC filter with a bandwidth of, for example, 10 kHz to 100 kHz.

The filtered signal from lowpass filter 416 is then provided to bias control generator 360a, which generates a bias control signal, V_{BIAS}, for each power amplifier stage having adjustable bias. Depending on the specific design of the power amplifier stages, the bias control signal, V_{BIAS}, may be a voltage or a current. The bias current (or voltage, depending on the specific design) of each adjustable power amplifier stage is then adjusted based on the associated bias control signal.

A function of bias control generator 360a is to translate the outputs of log amplifier 414 to the desire bias voltage or current that is designed to compensate the power amplifier as a function of RF output power and temperature. In this way, the overall desired (linear) transfer characteristic between the bias current, I_{BIAS}, and the detected signal, V_{DET}, is achieved. The output of log amplifier 414 may be used elsewhere in the system, so the transfer function of the power amplifier is applied by bias control generator 360a.

FIG. 4B is a diagram of another embodiment of a bias control circuit 360b, which is a digital implementation that may also be used for bias control circuit 360 in FIG. 3. Within circuit 360b, the detected signal, V_{DET}, from RF power detector 352 is provided to lowpass filter 418, which filters the RF envelope in the detected signal and provides the filtered signal. An analog-to-digital converter (ADC) 424 then receives and digitizes the filtered signal and provides samples to a processor 426.

Processor 426 implements a bias control algorithm and determines the proper bias for the power amplifier stages such that the desired results are achieved. Based on the detected RF power level and the bias control algorithm, processor 426 provides one or more digital controls for one or more power amplifier stages. The digital controls are provided to respective digital-to-analog converters (DACs) 428, which convert the digital controls to their corresponding analog bias control signals, V_{BIAS}, for one or more power amplifier stages. ADC 424, processor 426, and DACs 428 form a digital conditioning unit 420 that provides the desired overall characteristics for the power amplifier bias adjustment.

The digital implementation of bias control circuit 360b using processor 426 allows for flexible and accurate implementation of the desired transfer characteristic for each power amplifier stage to be adjusted. The desired overall transfer function between the bias for the power amplifier stage and the detected signal, V_{DET} (or the RF output power level) may be obtained (e.g., via empirical measurement or via computer simulation). The transfer function of each circuit in the bias adjustment loop may also be characterized. Processor 426 may then be designed to implement a particular transfer characteristic that, in combination with the transfer characteristics of the other circuits in the bias adjustment loop, provides the desired overall transfer characteristic. Processor 426 may implement the transfer function for each adjustable power amplifier stage using, for example, a look-up table or some other mechanism.

FIGS. 4A and 4B are two embodiments of bias control circuit 360. Other designs using analog and/or digital circuits may also be used and are within the scope of the invention. An example design of some of the elements of bias control circuit 360a and a power amplifier stage is described below.

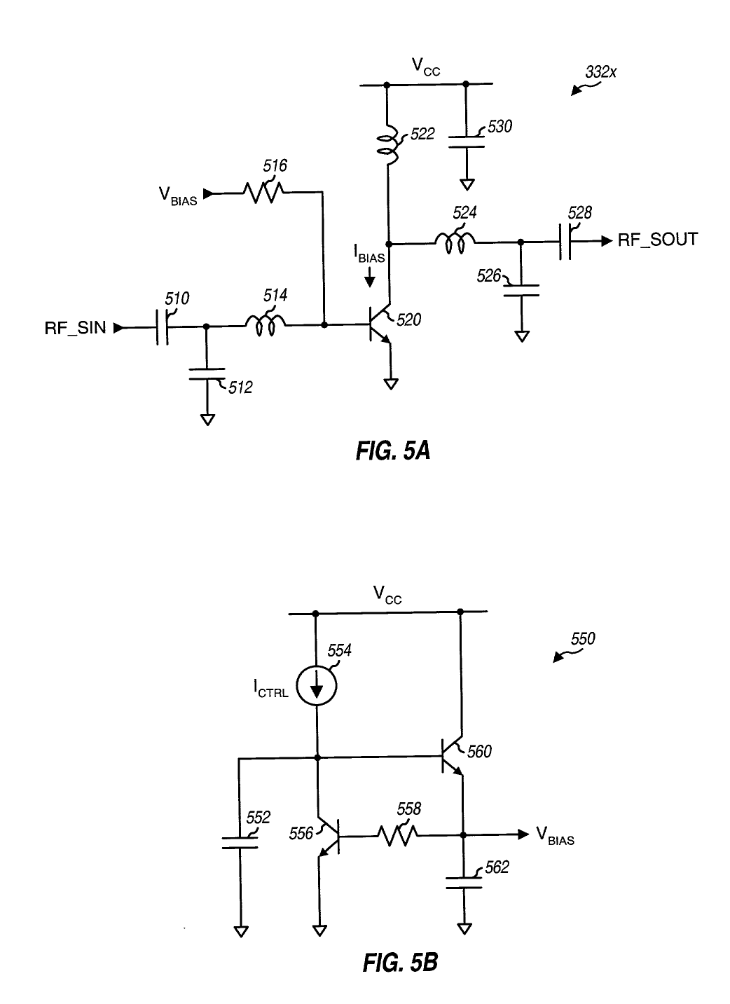

FIG. 5A is a schematic diagram of a specific design of an amplifier 332x, which may be used for any one of stages 332a through 332n in FIG. 3. Within amplifier 332x, the RF input for the stage, RF_SIN, is provided to one end of an AC coupling capacitor 510. The other end of capacitor 510 couples to one end of a capacitor 512 and one end of an inductor 514. The other end of capacitor 512 couples to AC ground, and the other end of inductor 514 couples to one end of a resistor 516 and to the base of a transistor 520.

In an embodiment, transistor 520 is an RF transistor (e.g., the BFP420 from Siemens, which is commonly used in the art). The emitter of transistor 520 couples to AC ground and the collector couples to one end of inductors 522 and 524. The other end of inductor 522 couples to the positive power supply, V_{CC}, and the other end of inductor 524 couples to one end of capacitors 526 and 528. The other end of capacitor 526 couples to AC ground, and the other end of capacitor 528 comprises the RF output for the stage, RF_SOUT. A bypass capacitor 530 couples between V_{CC} and AC ground.

Within amplifier 332x, capacitors 510 and 528 provide AC coupling of the RF input and RF output, respectively. Capacitor 512 and inductor 514 provide impedance matching for the amplifier input, and capacitor 526 and inductor 524 correspondingly provide impedance matching for the amplifier output. Inductor 522 provides a DC path for the bias current of transistor 520.

A bias control voltage, V_{BIAS}, is provided to resistor 516 and used to set the DC bias current, I_{BIAS}, for transistor 520. If the bias control voltage, V_{BIAS}, increases, more current is provided to the base of transistor 520, and the collector current increases correspondingly. The amount of bias current for transistor 520 determines the performance (e.g., linearity) of amplifier 332x, and higher bias current is generally required for higher RF output power level.

Amplifier 332x is one of many designs that may be used for power amplifier stages 332 in FIG. 3. Other designs may include fewer or greater number of passive and active components. Moreover, amplifier designs using various types of active component (e.g., bipolar transistor (BJT), field effect transistor (FET), and so on, or a combination thereof) may also be used. For example, a circuit analogous to amplifier 332x may be designed using FETs, and this analogous circuit can provide the same benefits using the bias control techniques described herein. Amplifier 332x is shown as an example of an amplifier design whereby the bias current may be adjusted by an externally generated bias control signal.

FIG. 5B is a schematic diagram of a specific design of a bias voltage generator 550 for amplifier 332x in FIG. 5A. Bias voltage generator 550 is a portion of bias control generator 416 in FIGS. 4A and 4B, and generates the bias control voltage, V_{BIAS}, used to set the bias current for amplifier 332x. Other designs may be used to generate the bias control voltage and are within the scope of the invention.

Within bias voltage generator 550, a current source 554 couples to the collector of a transistor 556, the base of a transistor 560, and one end a capacitor 552. The base of transistor 556 couples to one end of a resistor 558. The emitter of transistor 560 couples to the other end of resistor 558 and one end a capacitor 562, and provides the bias control voltage, V_{BIAS}. The other ends of capacitors 552 and 562 and the emitter of transistor 556 couple to AC ground. The collector of transistor 560 and current source 554 couple to the power supply, V_{CC}.

Transistor 556 is matched to transistor 520 of amplifier 332x but scaled in area. Resistor 558 is also matched to resistor 516 and scaled by the ratio of the size of transistor 520 over the size of transistor 556. Thus, transistors 520 and 556 effectively form a current mirror, and the bias current through transistor 520 is related to the current through transistor 556. Specifically, the bias current, I_{BIAS}, of amplifier 332x is related to the current, I_{CTRL}, of current source 554 as follows:

I_{BIAS}=K·I_{CTRL} Eq (2)

where K is a factor related to (1) the ratio of the area of transistor 520 over the area of transistor 556, (2) thermal and resistive contact details, and other factors. To a first-order approximation, K can be viewed as a constant. The current, I_{CTRL}, is adjusted as a function of the power amplifier RF output power to achieve a good combination of performance and power consumption. The current, I_{CTRL}, can be compensated to provide the desired amplifier bias current over temperature and power supply variations.

Within bias voltage generator 550, capacitor 562 provides RF decoupling, and capacitor 552 controls the stability of the bias voltage generator. Transistor 560 (which is conventionally known as a “beta helper”in bipolar current mirrors) improves the drive capability (in current) of the bias voltage generator. Transistor 560 provides signal drive for the bias control voltage, V_{BIAS}.

Although not shown in FIG. 5B for simplicity, bias control generator 416 includes circuitry that generates or adjusts the current, I_{CTRL}, based on the conditioned signal, V_{CON}, from log amplifier 414. This circuitry can be designed in a manner known in the art, and is thus not described herein.

FIGS. 5A and 5B show a specific design of an amplifier stage and the associated bias voltage generator, which may be used for the bias adjustment described herein. This amplifier design is described by way of illustration, and numerous other amplifier designs may also be used in conjunction with the bias adjustment techniques described herein.

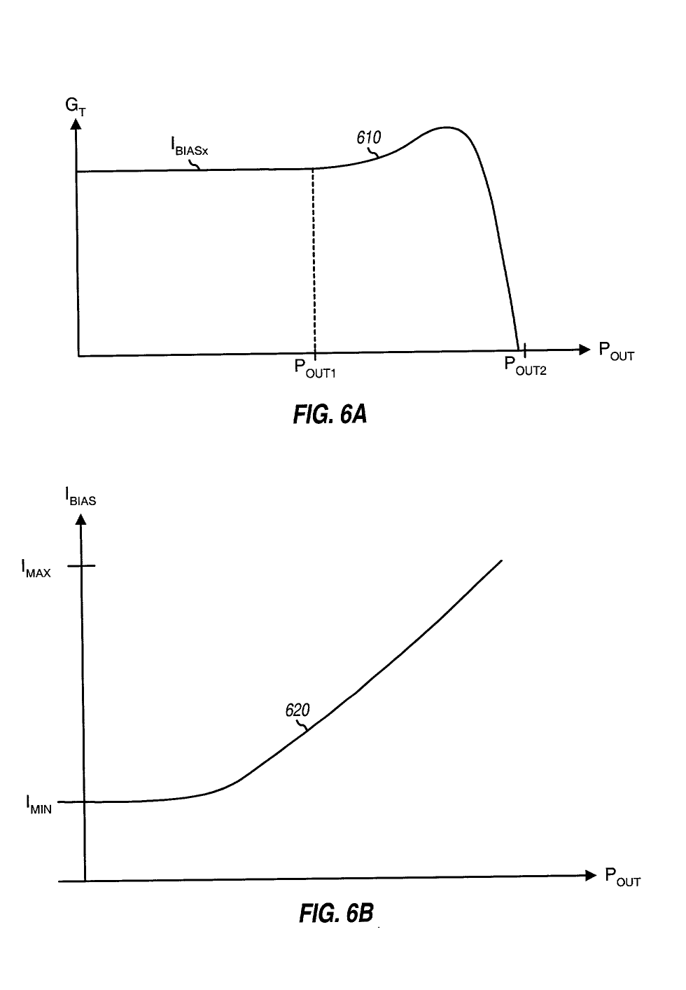

FIG. 6A is a diagram illustrating the gain of an amplifier stage versus RF output power level for a particular bias current setting. Plot 610 may be generated for amplifier 332x shown in FIG. 5A. For this plot 610, the bias current of the amplifier is maintained at a particular level, and the RF output power level is measured as the RF input power level is varied across a particular range. The gain, G_{T}, of the amplifier is then computed based on the measured RF input and output power levels and plotted versus the RF output power level, P_{OUT}.

As shown by plot 610, for a particular bias current setting, I_{BIASx}, the amplifier gain is approximately constant as the RF output power level, P_{OUT}, increases up to a first value, P_{OUT1} (e.g., +10 dBm). Thereafter, the amplifier gain expands and the RF output power level increases faster than the RF input power level, resulting in greater amplifier gain and a peaking in plot 610. As the RF output power further increases, the amplifier eventually compresses and the RF output power asymptotically reaches a second value, P_{OUT2} (e.g., +32 dBm). The amplifier gain also drops off abruptly as the RF output power reaches the asymptotic value, P_{OUT2}.

For CDMA systems, it is necessary to operate the power amplifier over a wide range of P_{OUT}, varying from very low power (e.g., well below P_{OUT1}) to the maximum level that the power amplifier is able to maintain performance (linearity). An optimal bias setting can be chosen for all power levels in this range. One such bias setting is shown in FIG. 6B.

FIG. 6A shows a plot generated for a single bias current setting. Similar plots may be generated for a series of bias current settings. These plots may then be used to identify the amount of bias current that should be used for various RF output power levels.

Other types of plot to characterize the performance of the amplifier versus bias current may also be generated. For example, a plot may be obtained for IIP3 versus bias current, as is known in the art.

FIG. 6B is a diagram illustrating the bias current of an amplifier stage versus RF output power level for the desired performance level. Plot 620 may be generated based on a series of plots generated as described above for FIG. 6A, or from other plots used to characterize the performance of the amplifier. For each bias current setting, the maximum RF output power that may be provided by the amplifier for the desired performance is determined. The bias current settings and their corresponding RF output power levels are then used to generate plot 620.

In an embodiment and as shown in FIG. 6B, the bias current is limited to a range between I_{MIN} and I_{MAX}. In an embodiment, the bias current of the amplifier is maintained at or above the minimum value of I_{MIN} to ensure proper operation of the amplifier even if the RF output decreases to a small value or is gated off. Correspondingly, the bias current of the amplifier is maintained at or below the maximum value of I_{MAX} to safeguard against excessive current usage.

Plot 620 is generated for a single amplifier stage. Similar plots may be generated for each amplifier stage having adjustable bias current. These plots may then be used to provide the proper bias current for the corresponding amplifier stages such that the desired performance is obtained while minimizing power consumption.

The bias currents of the power amplifier stages may be adjusted based on various bias adjustment schemes. The transfer function between the bias current and RF output power level is typically dependent on the specific design of the power amplifier stage, the desired performance level, and possibly other factors. In one scheme, the power amplifier RF output power level is detected. The gain for each amplifier stage may then be determined (e.g., based on prior characterization of the stages). Working backward through the stages, the RF output power level for a preceding stage (n-1) may be determined based on the RF output power level from the current stage (n) and the gain of the current stage. For each stage, the bias current for the stage may be determined based on the determined RF output power level for that stage and plot 620 generated for that stage.

Other schemes to generate the bias current for the power amplifier stages may also be implemented and are within the scope of the invention.

The RF output power, P_{OUT}, may be sampled using various techniques, and these sampling techniques are within the scope of the invention. Such techniques may include resistive coupling, coupler lines, and others. An example design of a circuit to sample the RF output power is described below.

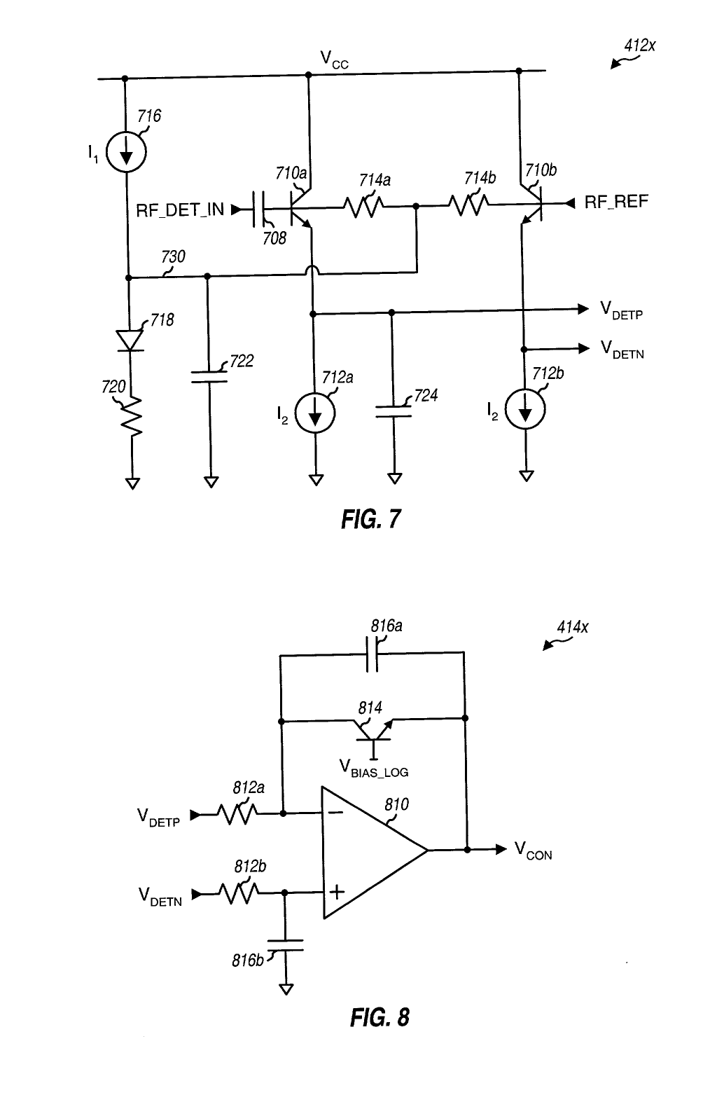

FIG. 7 is a schematic diagram of an embodiment of a power detector 412x, which may be used to detect the power level of the RF output signal. Power detector 412x is one specific implementation of peak detector 412 in FIG. 3. Power detector 412x receives an RF input, RF_DET_IN, and a reference voltage, RF_REF, and provides a differential detector output signal, V_{DETP} and V_{DETN}. The detector RF input is a fraction of the power amplifier RF output signal, and is provided by coupler 340.

Within power detector 412x, the detector RF input is provided to one end of a capacitor 708, and the other end of the capacitor couples to the base of a transistor 710a. The bases of transistors 710a and 710b respectively receive the detector RF input and the reference voltage, and further respectively couple to one end of resistors 714a and 714b. The emitters of transistors 710a and 710b respectively couple to current sources 712a and 712b and comprise the differential detector output signal, V_{DETP} and V_{DETN}. The collectors of transistors 710a and 710b couple to the power supply, V_{CC}. The other ends of resistors 714a and 714b couple together and to a current source 716, the anode of a diode 718, and one end of a capacitor 722. The cathode of diode 718 couples to one end of a resistor 720. The other ends of resistor 720 and capacitor 722 couple to AC ground. A capacitor 724 couples to the detector output, V_{DETP}, and AC ground.

Capacitor 708 provides AC coupling of the detector RF input, and the rectification of the detector RF input is achieved by transistor 710a. Current source 716 provides an approximately constant voltage at node 730. The current in each of current sources 712a and 712b is related to the current in current source 716 (i.e., I₂ [symbol] I₁). If the detector RF input voltage increases, the base-emitter voltage, V_{BE}, of transistor 710a increases, and more current is conducted through transistor 710a. Since current source 712a provides an approximately constant current, 12, the additional current charges capacitor 724 and increases the output voltage, V_{DETP}. Conversely, when the RF input voltage decreases, the current through transistor 710a decreases, and capacitor 724 discharges so that the sum of the emitter current from transistor 710a and the discharge current from capacitor 724 satisfies the constant current required by current source 712a. Transistor 710b and current source 712b produce the output voltage, V_{DETN}, which tracks a non-signal related operating point. When this voltage V_{DETN} is subtracted from V_{DETP}, the bias point offset (which may be temperature and IC process related) is removed.

FIG. 7 shows a specific design of a power detector that may be used to determine the power of an RF signal. Numerous other designs may also be used and are within the scope of the invention.

FIG. 8 is a schematic diagram of an embodiment of a log amplifier 414x, which is one specific implementation of log amplifier 414 in FIG. 4A. Log amplifier 414x receives the differential power detector output, V_{DETP} and V_{DETN}, and provides a conditioned signal, V_{CON}.

In the embodiment shown in FIG. 8, log amplifier 414x includes an amplifier 810 having an inverting input that couples to one end of a resistor 812a, the collector of a transistor 814, and one end of a capacitor 816a. The other end of resistor 812a receives the detector output, V_{DETP}. The non-inverting input of amplifier 810 couples to one end of a resistor 812b and one end of a capacitor 816b. The other end of resistor 812b receives the detector output, V_{DETN}, and the other end of capacitor 816b couples to AC ground. The base of transistor 814 couples to AC ground and is biased to the required bias voltage such that transistor 814 is turned ON over the entire input voltage (and output voltage) range. The output of amplifier 810 couples to the emitter of transistor 814 and the other end of capacitor 816a, and comprises the conditioned output, V_{CON}. The operation of log ampifier 414x is know in the art and not described herein.

Although not shown in FIG. 8 for simplicity, log amplifier 414x can be designed to provide temperature compensation. As shown in equation (2), the transfer function between V_{BE} and I_{DET} is dependent on V_{T}, which is a temperature dependent term. Temperature compensation may be achieved by a temperature compensation circuit coupled to the base of transistor 814, the output of amplifier 810, or both. The design of such temperature compensation circuitry is known in the art and not described herein.

As noted above, log amplifier 414x is used to convert the peak detector output to be proportional to P_{OUT} in dBm. Other designs for the log amplifier may also be used and are within the scope of the invention. Moreover, for some other power amplifier and/or control circuit designs, others compensation transfer characteristics (instead of a logarithmic transfer function) may be implemented.

For the digital design shown in FIG. 4B, the compensation transfer function may be digitally implement (e.g., with a look-up table) by processor 426. This allows for the implementation of a compensation transfer function having any shape. Moreover, a different compensation transfer function may be implemented for each bias adjustable power amplifier stage (instead of using one log amplifier for all stages). Thus, the digital design may provide more accurate adjustment of the bias for the stages.

The bias control techniques described herein provide efficient and accurate adjustment of the power amplifier bias to minimize power consumption while achieving the desired performance. The bias control techniques automatically adjust the bias current of the power amplifier as a function of the RF output power level. The adjustment is continuously performed based on a feedback loop (and not periodically adjusted based on changes in gain settings, as is done in some conventional bias control schemes). Moreover, the adjustment is based on the detected RF output power level (and not on some indirect indication of the power level, such as the gain settings). The techniques described herein may thus provide improved RF performance and reduced current consumption.

Second, the techniques described herein provide continuous, analog-like control/adjustment of the bias current. This can greatly reduce, or possibly eliminate, the amount of phase discontinuity in the RF output as the bias current is adjusted. In contrast, conventional schemes that adjust the bias current in (typically large) discrete steps are more likely to generate phase discontinuity (and of bigger magnitude) when the bias current is adjusted in discrete steps. This phase discontinuity may degrade the performance of the system, especially at high data rates supported by newer generation communication systems.

In FIG. 3, power amplifier 330 and control unit 350 are shown as two units. These units may be implemented within a single integrated circuit (IC), within separate ICs, or integrated with other circuits. For example, power amplifier 330 may be integrated within an RF IC, which may include all or a portion of control unit 350 (e.g., power detector 352, bias control generator 360a, and possibly other circuits). Depending on the specific implementation of control unit 350, some of the elements (e.g., processor 426) may be implemented within a digital unit (e.g., a processor, a digital signal processor (DSP), an application specific integrated circuit (ASIC), a controller, a field programmable gate array (FPGA), a programmable logic device, and so on).

The foregoing description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A bias controlled amplifier comprising:
one or more amplifier stages coupled together and configured to receive and amplify an input signal to provide an output signal; and
a control unit operatively coupled to the one or more amplifier stages and configured to detect a level of the output signal and, based on the detected output signal level, provide at least one bias control signal for adjusting a bias of at least one amplifier stage.

2. The bias controlled amplifier of claim 1, wherein each bias control signal adjusts a bias current of an associated amplifier stage.

3. The bias controlled amplifier of claim 1, wherein the control unit includes
a power detector configured to detect the output signal level and provide a detected signal indicative of the detected output signal level,
a conditioning unit coupled to the power detector and configured to receive and condition the detected signal to provide at least one conditioned signal, and
a bias control generator coupled to the conditioning unit and configured to receive the at least one conditioned signal and provide the at least one bias control signal.

4. The bias controlled amplifier of claim 3, wherein the conditioning unit is configured to provide a first transfer characteristic selected to provide a desired overall transfer characteristic for bias adjustment of the at least one amplifier stage.

5. The bias controlled amplifier of claim 4, wherein the first transfer characteristic approximates a logarithmic function.

6. The bias controlled amplifier of claim 4, wherein at least a portion of the conditioning unit is implemented with digital circuitry.

7. The bias controlled amplifier of claim 6, wherein the first transfer characteristic is implemented with a look-up table.

8. The bias controlled amplifier of claim 3, wherein the control unit further includes:
a lowpass filter configured to receive and filter the detected signal to provide a filtered signal, and
wherein the conditioning unit is configured to receive and condition the filtered signal.

9. The bias controlled amplifier of claim 8, wherein the lowpass filter is configured to filter an envelop in the detected signal.

10. The bias controlled amplifier of claim 3, wherein the power detector is configured to detect a power level of the output signal.

11. The bias controlled amplifier of claim 1, further comprising:
a coupler operatively coupled to an output stage of the one or more amplifier stages and configured to couple a portion of the output signal to the control unit.

12. The bias controlled amplifier of claim 1, wherein the control unit is configured to provide analog-like adjustment of the at least one bias control signal.

13. The bias controlled amplifier of claim 1, wherein the control unit is configured to continually detect the output signal level and update the at least one bias control signal.

14. The bias controlled amplifier of claim 1, wherein each bias control signal adjusts the bias of an associated amplifier stage to achieve a particular level of linearity.

15. The bias controlled amplifier of claim 14, wherein each bias control signal further adjusts the bias of the associated amplifier stage to reduce power consumption.

16. The bias controlled amplifier of claim 1, wherein each bias control signal adjusts the bias of an associated amplifier stage in a manner to reduce phase discontinuity in the output signal.

17. The bias controlled amplifier of claim 1, wherein each of the at least one amplifier stage is adjusted based on a respective transfer function of bias versus detected output signal level.

18. The bias controlled amplifier of claim 1, wherein each bias control signal is limited to within a range of values.

19. The bias controlled amplifier of claim 1, wherein each bias control signal has a minimum value.

20. The bias controlled amplifier of claim 1, wherein the one or more amplifier stages are coupled in series.

21. The bias controlled amplifier of claim 1, wherein the input signal is a CDMA modulated signal.

22. A bias controlled power amplifier comprising:
one or more amplifier stages coupled in series and configured to receive and amplify an input signal to provide an output signal;
a coupler operatively coupled to an output stage of the one or more amplifier stages and configured to couple a portion of the output signal;
a power detector coupled to the coupler and configured to detect a level of the output signal based on the coupled portion and provide a detected signal indicative of the detected output signal level;
a conditioning unit coupled to the power detector and configured to receive and condition the detected signal to provide at least one conditioned signal; and
a bias control generator coupled to the conditioning unit and configured to receive the at least one conditioned signal and provide at least one bias control signal for adjusting a bias of at least one amplifier stage.

23. A method for adjusting a bias of a multi-stage amplifier, comprising:
receiving and amplifying an input signal with one or more amplifier stages to provide an output signal;
detecting a level of the output signal;
conditioning a detected signal indicative of the detected output signal level to provide at least one conditioned signal;
forming at least one bias control signal based on the at least one conditioned signal; and
adjusting the bias of at least one amplifier stage with the at least one bias control signal.

24. The method of claim 23, wherein the conditioning is performed with analog circuitry having a first transfer characteristic selected to provide a desired overall transfer characteristic for bias adjustment of the at least one amplifier stage.

25. The method of claim 23, wherein the conditioning is performed with digital circuitry configured to implement a first transfer characteristic selected to provide a desired overall transfer characteristic for bias adjustment of the at least one amplifier stage.
